(19) United States
(12) Patent Application Publication
(10) Pub. No.: US 2008/0268333 A1
(43) Pub. Date: Oct. 30, 2008

(54) INTEGRAL BATTERY THERMAL MANAGEMENT

(76) Inventors: Joseph Barrella, Yonkers, NY (US); Philip H. Gow, Oakland, NJ (US)

Correspondence Address: ISRAEL NISSENBAUM, 1038-56TH ST, BROOKLYN, NY, 11219, US

(21) Appl. No.: 11/968,158

(22) Filed: Dec. 31, 2007

Related U.S. Application Data
(60) Provisional application No. 60/883,037, filed on Dec. 31, 2006.

(51) Int. Cl. H01M 10/50

(52) U.S. Cl. 429/120

(57) ABSTRACT

An electrochemical battery having at least one self contained thermoelectric cooling device such as a Peltier device, for cooling the battery to optimal operating conditions. The thermoelectric cooling device is contained within a housing of the battery and is in proximity to cells contained within the housing with the cooling device being electrically connected to the cells of the battery and an external electrical power source. A switching element is configured to selectively power the thermoelectric cooling device from the external electrical power source and with shut down of the external electrical power the switching element redirects power from the battery to the thermoelectric cooling device to effect continued cooling of the battery.

### FIELD OF THE INVENTION

The present invention relates to the integral thermal management of high energy density batteries and particularly lithium-ion batteries used under extended conditions of temperature extremes.

### BACKGROUND OF THE INVENTION

Effective thermal management of battery packs has been recognized as a necessary condition to achieve consistent performance and long life of battery systems.

As the number of cells in a battery increases, and as the size of the cells increases, so does the necessity and benefit of providing suitable thermal management. Differences in temperatures affect the resistance, self discharge rate, coulombic efficiency, as well as the irreversible capacity and power fade rates of battery cells, over a wide range of chemistries. By maintaining uniform thermal conditions for all cells in a battery pack or module, the likelihood of cell state of charge imbalance and of early failure of non-defective cells is minimized.

All battery cells generate heat when cycled due to resistive losses, electrode charge/discharge voltage hysteresis, side shuttle reactions, and in aqueous recombinant batteries from gassing/recombination mechanisms. Entropic heat shuttling can further increase the thermal load during charge (e.g. NiMH) or during discharge (e.g. NiCd). Comparing the charge and discharge energies for full 100% cycles of a battery chemistry allows the calculation of total cyclic waste heat generation for a given charge/discharge profile. Lithium ion chemistries typically have a much smaller voltage hysteresis as compared with nickel based systems, providing for a much lower baseline inefficiency of cycling for a given capacity of cell. This is further enhanced by the higher (˜3×) nominal voltage of lithium systems.

Many approaches have been used to ensure the maintenance of uniform cell temperatures in battery systems. These approaches are most frequently concerned with externally situated expedients with heat removal, usually employing free convection or forced convection of heat conducted through cell case walls and/or cell terminals to an ambient or thermally conditioned fluid stream, typically consisting of air or an antifreeze solution. Other, more recent developments, have included the use of heat absorbing phase change materials.

These approaches work well in many applications, particularly where the ambient temperatures do not regularly exceed 35-45 degrees centigrade for extended periods. Moreover, when these approaches do not involve use of a phase-change refrigerant system, but only require the power for a fan and or fluid pump, they can result in a high coefficient of performance where Cp is defined as the ratio of heat removed to energy expended to remove the heat.

Where systems have employed refrigerated fluids to cool the cells, such as with Saft's liquid cooled EV battery modules from the 1990's, the net effect has been to greatly decrease the operating electrical efficiency of the system, and either to add extra thermal conditioning hardware (compressors, condensers, etc), or overuse and shorten the life of existing vehicle AC units, such as with GMs' S-10 and EV1 electric vehicles of the 1990's. Moreover with the use of conditioned, non-recirculated air, considerable moisture condensation can result in accumulation of significant quantities (gallons) of water whenever the thermal management system is in operation. This was experienced with GMs EV1, creating a disposal problem when the vehicle was charged in a confined non-drained space, such as a home garage.

Other systems, used under conditions of low temperature extremes, have made provision for heating the cells, most commonly employing electrically resistive heating elements placed in effective thermal contact with cell casings or the thermal fluid stream.

### SUMMARY OF THE INVENTION

It is an object of the present invention to provide a battery particularly comprised of lithium ion cells and internal device which are stand alone, such that the battery power itself can power the heating/cooling device and/or such device can be powered by vehicle or outside power with condition selective powering of the device. If placed on a vehicle, and such vehicle power is available, the Internal Battery Thermal Management (IBTM) device will either heat or cool the battery to avoid excessive thermal excursion and regulate such for improved operational (discharge) performance. When vehicle power is not available, the device switches to direct powering by the battery itself

As an example, in today's combat vehicles such vehicles electronic systems are designed to operation with “engine off” capability (Silent Watch) totally using battery power. In war theaters such as Iraq, the battery temperatures reach close to maximum while in the desert, during daily temperatures excursions. When such vehicles are transitioned to Silent Watch mode, the already high battery temperatures can limit the usefulness of the battery and/or operating life by causing the battery temperature to be high on initial start and rise further to potentially degrading temperatures.

The use of this invention in this example provides cooling within the battery such that the battery is able to start at below desert heat conditions and utilize the battery power to further limit potential over temperatures conditions if they should arise. This is accomplished by, as an example, internal condenser, heat exchanger or thermal electric device such as Peltier units which can provide both cooling or heating, as desired.

During Silent Watch/vehicle off, the IBTM is powered by the battery itself and prior to vehicle engine off by the vehicle power.

The above and other objects, features and advantages of the present invention will become more evident from the following discussion and drawings in which:

### SHORT DESCRIPTION OF THE DRAWINGS

FIG. 1 is a perspective view of a battery with cover removed to show contents and cells;

FIG. 2 schematically depicts a heat transfer sink with extension fingers, as contained in the battery of FIG. 1; and

FIG. 3 schematically depicts cooling device power transfer from vehicle to internal battery power.

### DETAILED DESCRIPTION OF THE INVENTION AND DRAWINGS

Generally the present invention comprises an integral thermal management system for an electrochemical battery having at least one self contained thermoelectric cooling device, for cooling the battery to optimal operating conditions. The thermoelectric cooling device is contained within a housing of the battery and in proximity to cells contained within the housing. The cooling device is preferably electrically connected to the cells of the battery and an external electrical power source with a switching element being configured to selectively power the thermoelectric cooling device from the external electrical power source and with shut down of the external electrical power, the switching element redirects power from the battery to the thermoelectric cooling device to effect continued cooling of the battery. Alternatively, the thermoelectric cooling device is only powered by the internal battery power.

The present invention comprises using thermoelectric (i.e., electrically operable thermal control) devices, such as Peltier devices to heat and cool (thermally manage) batteries and battery cells. The Peltier effect is the creation of a heat difference from an electric voltage. It occurs when a current is passed through two dissimilar metals or semiconductors (n-type and p-type) that are connected to each other at two junctions (Peltier junctions). The current drives a transfer of heat from one junction to the other: one junction cools off while the other heats up; as a result, the effect is often used for thermoelectric cooling. Peltier devices are commercially available through various sources such as from Ferrotec and Tellurex corporations. Though Peltier devices have lower cooling efficiencies when compared to other cooling devices they are completely solid state and much more resistant to untoward conditions with high reliability. Their use has become economical and they can be linked in series to boost cooling performance with improved cell performance and life. The control of such devices may be effected using a diverse array of means—from simple bimetallic thermal switches, to solid state-based operational controls embedded in a battery management system (BMS) microcontroller.

In the case of automotive applications, the thermal management system preferably is configured to operate when the engine or an auxiliary power unit is running, pre-cooling or preheating the system, with power derived from the engine or auxiliary power unit, and only running from battery power when more disadvantageous or deleterious thermal conditions are vehicle shut down conditions (e.g. Silent Watch) are encountered.

The energy to power these thermal management devices is provided from the battery system as a whole, from an external power supply, or from individual cells within the battery system. This last self-powered method provides a means for discharging balancing individual battery cells without generating excessive waste heat in the battery management system as is normally the case using dissipative balancing resistors.

The thermoelectric devices are preferably in intimate thermal contact with the cell(s), either through the cell walls and/or cell terminal(s), either directly or indirectly through a conductive means such as a thermally conductive material which may comprise one or more of the following states: solid, gelled, slurry or paste, liquid or gas.

The heat transferred in or out of the cells is employed, for example, with any of a variety of sources or sinks, such as the structure of a vehicle or building, ambient or thermally conditioned fluids such as air (employing free or forced convection), an aqueous or non-aqueous stream or pool, a phase change material, and the like. Additionally, the source or sink may be thermally conditioned by a variety of means including, but not limited to solar, waste exhaust heat, etc. The source or sink may be selectable from a multiple arrangement with either selected or integrated depending on requirements to provide a thermal sink or source from a particular desired sink or source temperature, dpending on operational efficiency.

Peltier devices and other thermoelectric devices utilizable in the present invention are available in thin modules and can provide a coefficient of performance of unity or above if lightly loaded with a small temperature differential, and considerably less if heavily loaded or used to pump heat against a large thermal differential. Temperature differentials of 30 C. can be maintained with reasonable performance (Cp=0.5): for example see: http://www.melcor.com/UTSERIES/UT8-12-25-F2.PDF for more details. Though this type of heat pump does not provide for the highest energy efficiency, it enables longer life and avoidance of extreme temperatures in harsh environments. In addition, these units are simpler, more compact, lighter weight and more robust to shock and vibration than a fluid based thermal management system, especially one employing liquids and or refrigerants.

A preferred embodiment of such a scheme involves insulating the gap between the cell case and the battery system outer case while in selected areas bridging that gap with thermoelectric devices to provide controlled heat transfer. Furthermore, the outside wall of the battery case should be thermally conductive and employ heat sinking, integrally or as an add-on. Heat gathering/distribution plates or gels or liquids of a thermally conductive material may be used inside the battery system to conduct the heat between the cell(s) and the thermoelectric device.

In one embodiment, the battery system outer case (e.g., with heat sink-fins) may form a sandwich-structure with the inner, heat distributing plate, thus improving rigidity of the system and allowing for decreased weight due to the inherent structural efficiency of a sandwich based structure. The inner heat distributing plate may have branches or fingers or surface features or partition walls to allow efficient distribution of heat to and from the cell casing(s).

Resistive elements may be added into or used adjacent to the thermoelectric devices for heating the battery as they always operate at a coefficient of performance of unity, and also to avoid some of the issues associated with applying reverse polarity to some Peltier thermo-electric products. These resistive devices may also be powered from the same range of sources as the thermoelectric devices.

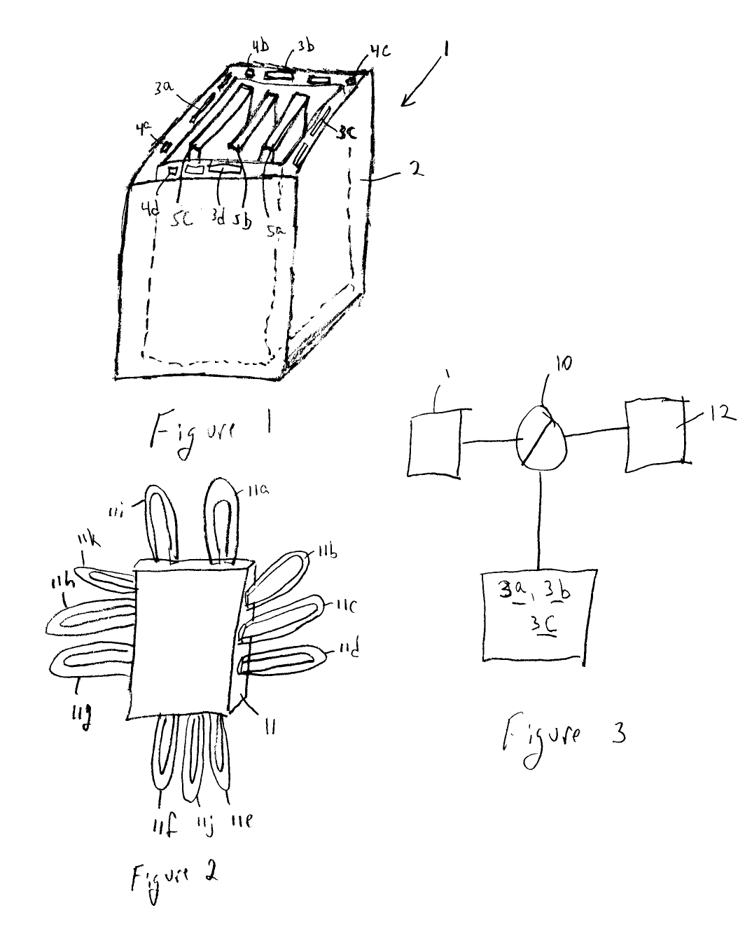

With specific reference to the drawings, in FIG. 1 a battery 1, with cover removed is shown to contain the flat lithium ion cells 5a-c within battery housing 2. The cells are spaced from the housing walls, which are preferably insulated, in order to directly accommodate cooling elements such as Peltier device modules 3a-d placed around the cells for enhanced efficiency and to control subsequent heat build up. Additional modules may be positioned directly between the cells with minimal structural disruption since the modules are relatively thin. Other components such as heat sinks 11 (shown with extending fingers 11a-k) in FIG. 2 and resistive elements 4a-d, for heating the battery in low temperature ambient conditions, are similarly positioned around the cells and within the battery housing. As opposed to current systems the battery of the present invention is self contained.

As depicted in FIG. 3, the thermoelectric devices 3a-d are electrically connected to both an external power source such as a military vehicle 12 and the internal battery cells with a transfer switch 10. The switch is operable to direct power from the vehicle or other outside power source to the thermoelectric cooling devices. With a shutdown of the external power such as on Silent Watch, the switch transfers direction of the power from the battery to the thermoelectric cooling devices. The cells 5a-c are preferably of the lithium ion type electrochemistry especially since such cells are high energy density cells with a greater susceptibility to high ambient temperature degradation.

It is understood that above drawings and description are only exemplary of the present invention and that changes may be made to structures and components without departing from the scope of the present invention as defined in the following claims.

What is claimed is:

1. An electrochemical battery having at least one self contained thermoelectric cooling device, for cooling the battery to optimal operating conditions, the thermoelectric cooling device being contained within a housing of the battery and in proximity to cells contained within said housing with said cooling device being electrically connected to the cells of the battery and an external electrical power source wherein a switching element is configured to selectively power the thermoelectric cooling device from the external electrical power source and with shut down of the external electrical power the switching element redirects power from the battery to the thermoelectric cooling device to effect continued cooling of the battery.

2. The electrochemical battery of claim 1, wherein the thermoelectric cooling device is a Peltier device.

3. The electrochemical battery of claim 2, wherein the thermoelectric cooling device further contains at least one of a heat sink and and a resistive element.

4. The electrochemical battery of claim 2, wherein the battery is comprised of at least two lithium ion cells.

5. An electrochemical battery having at least one self contained thermoelectric cooling device, for cooling the battery to optimal operating conditions, the thermoelectric cooling device being contained within a housing of the battery and in proximity to cells contained within said housing with said cooling device being electrically connected to the cells of the battery to effect continued cooling of the battery.
